(19) United States
(12) Patent Application Publication
(10) Pub. No.: US 2023/0346156 A1
(43) Pub. Date: Nov. 2, 2023

(54) SYSTEM AND METHOD FOR USING A SUPPLEMENT BEVERAGE DISPENSING MACHINE

(71) Applicants: Mary Allison, Petawawa (CA); Nolan Allison, Petawawa (CA)

(72) Inventors: Mary Allison, Petawawa (CA); Nolan Allison, Petawawa (CA)

(21) Appl. No.: 18/309,059

(22) Filed: Apr. 28, 2023

Related U.S. Application Data
(60) Provisional application No. 63/336,721, filed on Apr. 29, 2022.

(51) Int. Cl. A47J 31/52; A47J 31/40; A47J 31/44

(52) U.S. Cl. CPC A47J 31/521; A47J 31/404; A47J 31/4482

(57) ABSTRACT

A system and method for using a supplement beverage dispensing machine is provided. The system includes a supplement beverage dispensing machine having a housing with an external touch display screen and controls, a vending outlet having a lower tray adapted to support a beverage container, and a plurality of solid material reservoirs disposed within an interior volume of the housing configured to store one or more protein powders, one or more dried greens powders, one or more pre-workout powders and post-workout powders, or other types of supplement powders and at least one liquid material reservoir that includes water or other mixing liquids therein. The overall system includes a method of use and a non-transitory computer storage media to prepare a beverage in a selected container size with a selected combination of supplement types and quantities with the overall system.

### CROSS REFERENCE TO RELATED APPLICATIONS

This application claims the benefit of U.S. Provisional Application No. 63/336,721 filed on Apr. 29, 2022. The above identified patent application is herein incorporated by reference in its entirety to provide continuity of disclosure.

### BACKGROUND OF THE INVENTION

The present invention relates to a system and method for using a beverage dispensing machine. More specifically, the invention relates to a system and method for using a supplement beverage dispensing machine.

In addition to proper exercise, managing the intake consumption of an individual is important to healthy living. Specifically, the consumption of protein and supplements may promote the muscle growth to achieve the desired effect. Proteins needed for such growth may come from different types of food. However, individuals may opt to consume the proteins and other supplements in shakes and drinks. Typically, these proteins and other supplements are packaged as a powder that an individual may easily incorporate in their supplement drinks. The powder form of the proteins may be packaged in large containers or bags that need proper storage to avoid going stale. Additionally, these containers are not convenient for transporting. Thus, individuals which do not prepare their supplement drink with the protein powder, will be unable to consume the proteins immediately following their workout, which is the optimal time which to consume them. Moreover, if the individual is unable to properly store the protein powder or finish the protein in the suggested time following the opening of the containers or bags, the powders may expire. With the high cost of such proteins or supplements, the costs endured may be high.

What is needed is a system and method for using a supplement beverage dispensing machine that provide users with a supplement beverage mixing and dispensing machine for use to quickly obtain a protein-based beverage or other supplement drink for consumption.

### SUMMARY OF THE INVENTION

In view of the foregoing disadvantages inherent in the known types of systems and methods for using a supplement beverage dispensing machine now present in the prior art, the present invention provides a system and method for using a supplement beverage dispensing machine wherein the same may be utilized for providing convenience for a user when using a system and method for using a supplement beverage dispensing machine.

The present system comprises a system and method for using a supplement beverage dispensing machine that includes a server system with a processor system, a communications interface, a communications system, an input system and an output system, the server system having access to a communications network; a memory system with an operating system, a communications module, a web browser module, a web server application and a non-transitory storage media for using a supplement beverage dispensing machine, the memory system is in communication with the server system through the communications network; and a supplement beverage dispensing machine having an external touch display screen, the non-transitory storage media for using a supplement beverage dispensing machine includes a plurality of graphical user interfaces displayed on the external touch display screen; and wherein the supplement beverage dispensing machine includes a vending outlet, a housing, a plurality of solid material reservoirs, the external touch display screen, an internal volume, and at least one liquid material reservoir.

The present system also includes a corresponding method for using a supplement beverage dispensing machine that includes the steps of placing a beverage container in the supplement beverage dispensing machine, orienting a beverage container under a dispensing mechanism of the supplement beverage dispensing machine, dispensing the supplement beverage into the beverage container with a desired combination of supplement powders and quantities dispensed from the dispensing mechanism, and ceasing the dispensing mechanism when the beverage container is filled.

The present system also includes a corresponding non-transitory computer storage media having instructions stored thereon which, when executed, execute a method comprising the steps of placing a beverage container in the supplement beverage dispensing machine, orienting the beverage container under a dispensing mechanism of the supplement beverage dispensing machine, dispensing the supplement beverage into the beverage container with a desired combination of supplement powders and quantities dispensed from the dispensing mechanism, and ceasing the dispensing mechanism when the beverage container is filled.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of a system for using a supplement beverage dispensing machine.

FIG. 2A shows a block diagram of a client system of the system for using a supplement beverage dispensing machine.

FIG. 2B illustrates a block diagram of a server system of the system for using a supplement beverage dispensing machine.

FIGS. 3A and 3B shows a pair of close-up perspective views of an embodiment of the supplement beverage dispensing machine.

FIG. 4 shows a close-up view of an embodiment of the supplement beverage dispensing machine.

FIG. 5 shows a close-up view of an embodiment of the supplement beverage dispensing machine.

FIG. 6 shows a close-up view of an embodiment of the supplement beverage dispensing machine.

FIG. 7 shows a hand-held device of the supplement beverage dispensing machine.

FIG. 8 shows a flowchart for a method for using a supplement beverage dispensing machine.

### DETAILED DESCRIPTION OF THE INVENTION

Reference is made herein to the attached drawings. Like reference numerals are used throughout the drawings to depict like or similar elements of a system and method for using a supplement beverage dispensing machine. The figures are intended for representative purposes only and should not be considered to be limiting in any respect.

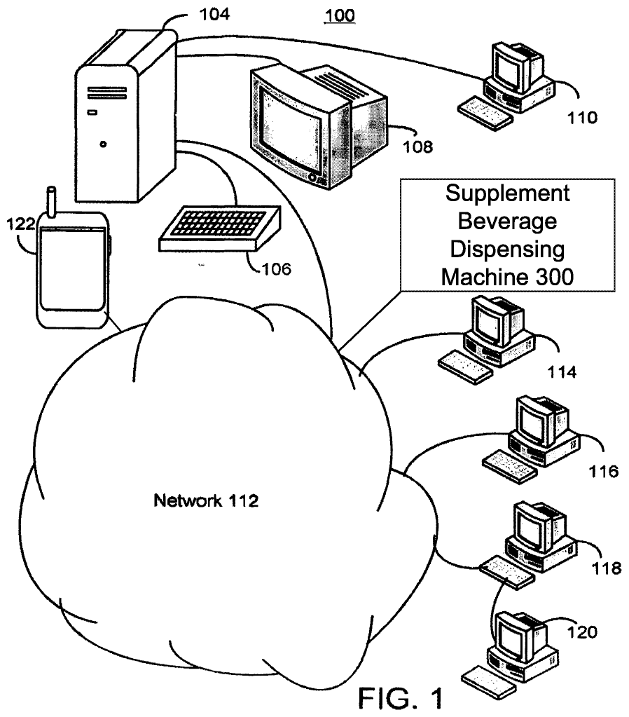

Referring now to FIG. 1 there is shown a system overview of a system for using a supplement beverage dispensing machine 100.

The overall system 100 includes a server system 104, an input system 106, an output system 108, a plurality of client systems 110, 114, 116, 118 and 120, a communications network 112, a hand-held device 122 and a supplement beverage dispensing machine 300. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

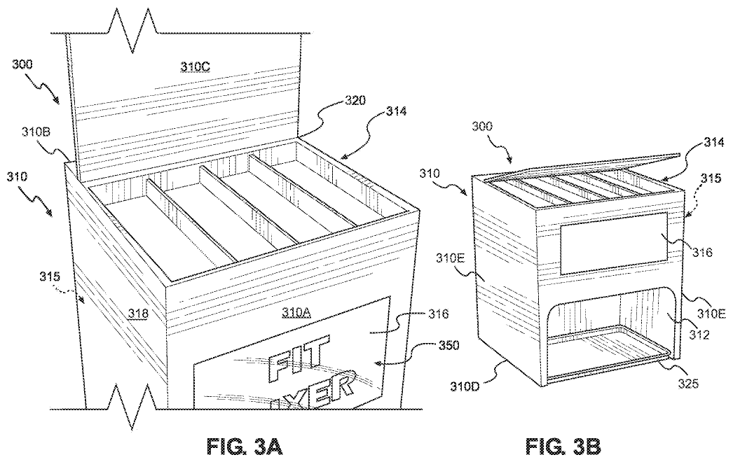

The supplement beverage dispensing machine 300 is described in more detail in FIGS. 3-7.

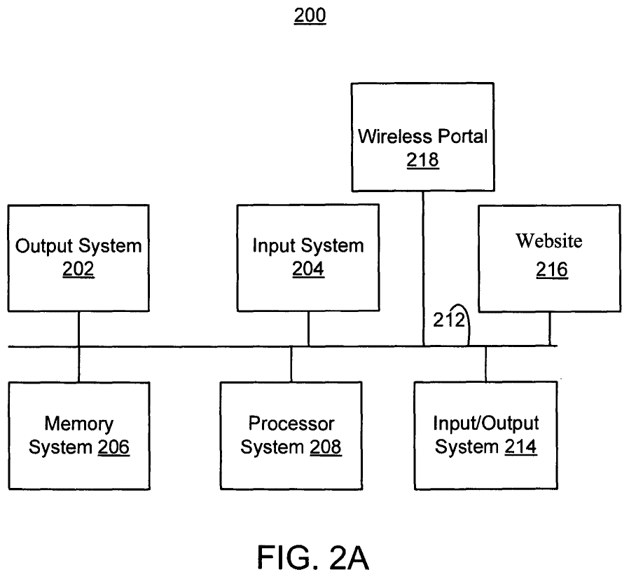

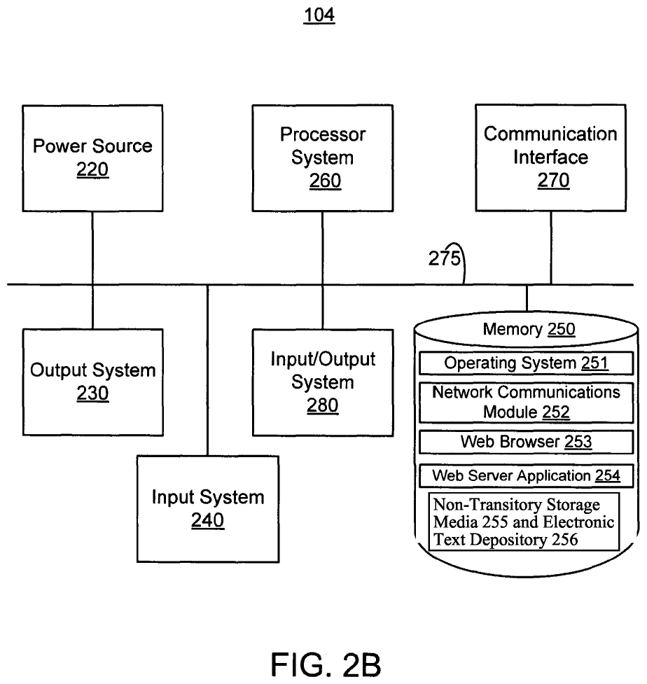

Referring now to FIG. 2A there is shown a block diagram of a client system 200 of the system for using a supplement beverage dispensing machine 100.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a non-transitory storage media for using a supplement beverage dispensing machine.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include software and a website module (no number) to maintain, allow access to and run the website as well.

FIG. 2B shows a block diagram of a server system 104 of the system for using a supplement beverage dispensing machine 100.

The server system 104 may include a power source 220, an output system 230, an input system 240, a memory system 250, which may store an operating system 251, a communications module 252, a web browser module 253, a web server application 254, and a non-transitory storage media for using a supplement beverage dispensing machine 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store one or more machine instructions for reading, searching and enhancing a system and method for using a supplement beverage dispensing machine. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

FIGS. 3A and 3B shows a pair of close-up perspective views of an embodiment of the supplement beverage dispensing machine 300.

The supplement beverage dispensing machine 300 may include a housing 310.

The housing 310 may include a vending outlet 312, a plurality of solid material reservoirs 314, and an external touch display screen 316. The housing 310 may include a front face 310A, a rear face 310B, a top face 310C, a bottom face 310D, and a pair of side faces 310E. The housing 310 may further include an internal volume 315. The top face 310C of the housing 310 may be attached to the rear face 310B via a hinge 320 or the like and serve as a lid for the housing 310.

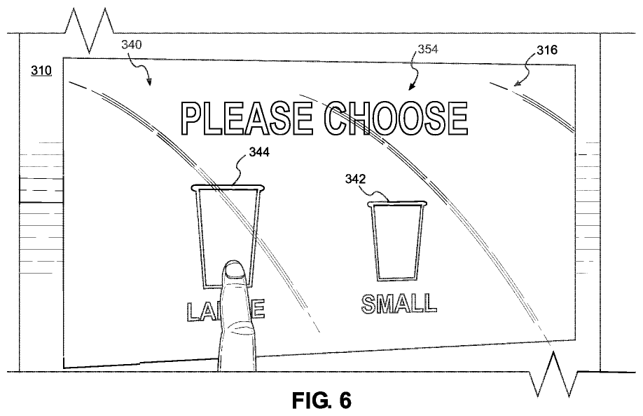

The vending outlet 312 and the external touch display screen 316 may be disposed on the front face 310A of the housing 310, wherein the vending outlet 312 may be positioned closer to the bottom face 310D than the external touch display screen 316. The vending outlet 312 may include a lower tray 325 adapted to support a beverage container (FIG. 6, 340). The solid material reservoirs 314 and at least one liquid material reservoir 318 may be disposed within the internal volume 315. The solid material reservoirs 314 may be configured to store one or more protein powders, one or more dried greens powders, one or more pre-workout powders, one or more post-workout powders, one or more other types of supplement powders, or the like. The at least one liquid material reservoir 318 may be configured to store water or other mixing liquids or the like therein.

The external touch display screen 316 includes a plurality of graphical user interfaces 350 displayed on the external touch display screen 316. The non-transitory storage media for using a supplement beverage dispensing machine (FIG. 2B, 255) controls a plurality of graphical user interfaces or GUIs 350 displayed on the external touch display screen 316.

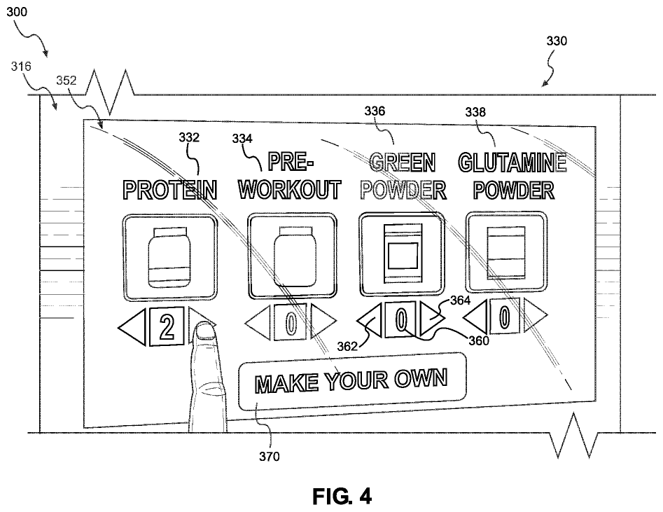

FIG. 4 shows a close-up view of an embodiment of the supplement beverage dispensing machine 300.

The supplement beverage dispensing machine 300 may include the external touch display screen 316 and a first graphical user interface 352. The first graphical user interface 352 displayed on the external touch display screen 316 may be adapted to allow a user to select a plurality of ingredient combinations 330 by touching the external touch display screen 316. The ingredient combinations 330 may include a protein powder 332, a pre-workout powder 334, a green powder 336, and a glutamine powder 338 or the like. Each of the ingredient combinations 330 may include a digital numerical display 360 each having a first side arrow 362 and a second side arrow 364 that may be depressed on the external touch display screen 316 to select a desired quantity of each of the ingredient combinations 330. There is also a “Make Your Own” button 370 disposed on the first graphical user interface 352 that may be depressed after selecting a desired quantity of each of the ingredient combinations 330 to activate the supplement beverage dispensing machine 300.

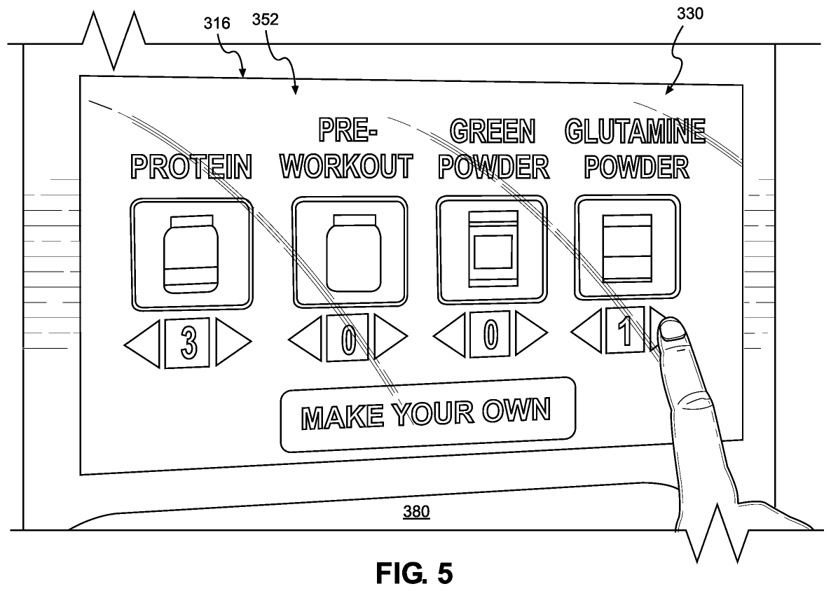

FIG. 5 shows a close-up view of an embodiment of the supplement beverage dispensing machine 300.

The supplement beverage dispensing machine 300 may include the external touch display screen 316 and the first graphical user interface 352.

The non-transitory storage media for using a supplement beverage dispensing machine (FIG. 2B, 255) prepares a supplement beverage in the beverage container size (FIG. 6, 340) with a selected combination of the ingredient combinations 330 and their respective quantities. When the user selects the ingredient combinations 330 from each of the beverage ingredient combinations 330, a dispensing mechanism 380 is adapted to mix ingredients and water from the reservoirs and dispense the resulting supplement beverage.

The non-transitory storage media for using a supplement beverage dispensing machine (FIG. 2B, 255) is controlled by the GUIs (FIGS. 3A and 3B, 350) displayed on the external touch display screen 316. The user may touch the GUIs 350 displayed on the external touch display screen 316 to enter information that is processed by the non-transitory storage media for using a supplement beverage dispensing machine 255 to operate the supplement beverage dispensing machine 300 to make and dispense the desired supplement beverage.

FIG. 6 shows a close-up view of an embodiment of the supplement beverage dispensing machine 300.

The supplement beverage dispensing machine 300 may include the external touch display screen 316 and a second graphical user interface 354. The second graphical user interface 354 displayed on the external touch display screen 316 may be adapted to allow a user to select a plurality of beverage container sizes for the beverage container 340. The beverage containers sizes 340 may be a large beverage container size 344 or a small beverage container size 342 or the like. The beverage containers 340 may be stored within the housing 310 and be automatically retrieved during a dispensing cycle of the supplement beverage dispensing machine 300.

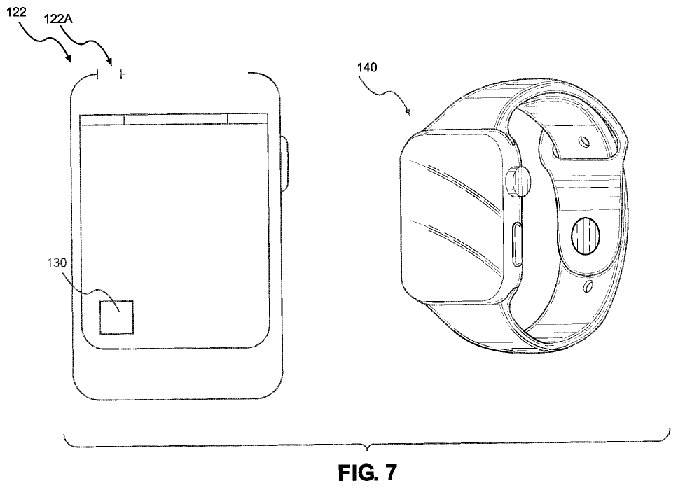

FIG. 7 shows a hand-held device (FIG. 1, 122) of the system for using a supplement beverage dispensing machine (FIG. 1, 100).

The hand-held device 122 may be a cellular telephone with an integrated computer or SMARTPHONE® 122A or the like. The hand-held device 122 may receive a mobile smart app 130 to download on the hand-held device 122 from a traditional mobile smart app source such as the App Store or the like. The mobile smart app 130 may also be accessed through a wearable computing device that closely resembles a wristwatch or other time-keeping device or SMARTWATCH® 140 or the like. The mobile smart app 130 may ask a number of questions to a user involving allergies, daily protein goals, daily supplement goals, number of people using the machine, specific products being used in the machine, or the like.

The mobile smart app 130 includes approximately 3 to 4 mixing cups to always have a cup under the dispenser at all times. The mobile smart app 130 may not dispense liquid if there is no cup underneath the supplement beverage dispensing machine (FIGS. 3A and 3B, 300). The mobile smart app 130 may send a notification to the SMARTPHONE® 122A and the SMARTWATCH® 140 if the user has not reached their respective protein or supplement goal. The mobile smart app 130 may have an option to the supplement beverage dispensing machine 300.

The mobile smart app 130 may track one or more workouts and sense if a user has completed a workout and offer to mix the supplement beverage in the supplement beverage dispensing machine 300. The supplement beverage dispensing machine 300 may also be preset. For example, if a user would like to have a pre-workout drink mixed at approximately 6:00 AM, the user may use the mobile smart app 130 to set this. A user may also set the mobile smart app 130 to grab a protein shake after a workout at 7:45 AM. The mobile smart app 130 may send notifications if one of the solid material reservoirs (FIGS. 3A, 3B, 314) or the at least one liquid material reservoir (FIGS. 3A, 3B, 318) are running low on a supplement or water to insure they are refilled. The system for using a supplement beverage dispensing machine 100 may be utilized at a gym or the like, where the user may access the mobile smart app 130 and pay the gym through the mobile smart app 130 for each supplement drink. The mobile smart app 130 may include a self-cleaning feature or use of one or more self-cleaning pods to control cross-contamination in the supplement beverage dispensing machine 300.

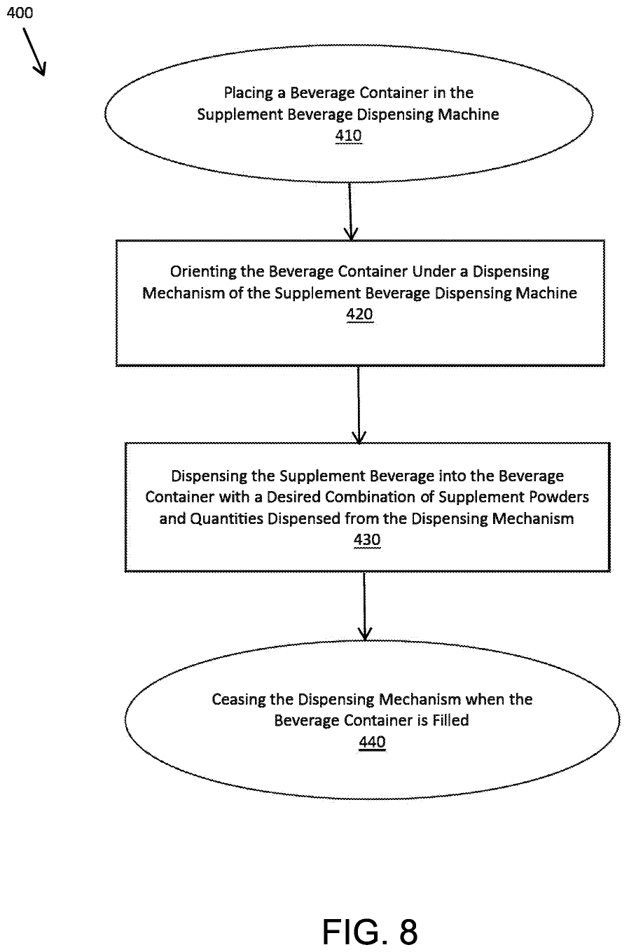

FIG. 8 shows a flowchart for a method for using a supplement beverage dispensing machine 400.

The overall method 400 includes the steps of placing a beverage container in the supplement beverage dispensing machine 410, orienting the beverage container under a dispensing mechanism of the supplement beverage dispensing machine 420, dispensing the supplement beverage into the beverage container with a desired combination of supplement powders and quantities dispensed from the dispensing mechanism 430, and ceasing the dispensing mechanism when the beverage container is filled 440.

The placing step 410 may include the beverage container is placed upon a lower tray of the supplement beverage dispensing machine.

The orienting step 420 may include the beverage container dispenses a supplement beverage from a plurality of solid material reservoirs having one or more protein powders, one or more dried greens powders, one or more pre-workout powders and one or more post workout powders, and one or more other types of supplement powders and at least one liquid material reservoir is configured to store water or other mixing liquids.

The dispensing step 430 may include a first graphical user interface displayed on the external touch display screen is adapted to allow a user to select a plurality of ingredient combinations by touching the external touch display screen and a second graphical user interface displayed on the external touch display screen is adapted to allow the user to select a plurality of beverage container sizes for the beverage container.

The ceasing step 440 may include the beverage containers size is a large beverage container size or a small beverage container size.

A non-transitory computer storage media having instructions stored thereon which, when executed, executes the overall method.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system, comprising:
a server system with a processor system, a communications interface, a communications system, an input system and an output system, the server system having access to a communications network;
a memory system with an operating system, a communications module, a web browser module, a web server application and a non-transitory storage media for using a supplement beverage dispensing machine, the memory system is in communication with the server system through the communications network; and
a supplement beverage dispensing machine having an external touch display screen, the non-transitory storage media for using a supplement beverage dispensing machine includes a plurality of graphical user interfaces displayed on the external touch display screen;
wherein the supplement beverage dispensing machine includes a vending outlet, a housing, a plurality of solid material reservoirs, the external touch display screen, an internal volume, and at least one liquid material reservoir; and
wherein the at least one liquid material reservoir is configured to store water or other mixing liquids.

2. The system according to claim 1, further comprising a client system that accesses the server system via the communications network.

3. The system according to claim 2, wherein the client system is a smart phone.

4. The system according to claim 2, wherein the client system is a smart watch.

5. The system according to claim 1, wherein the non-transitory storage media for using a supplement beverage dispensing machine controls the graphical user interfaces displayed on the external touch display screen.

6. The system according to claim 5, wherein a first graphical user interface displayed on the external touch display screen is adapted to allow a user to select a plurality of ingredient combinations by touching the external touch display screen.

7. The system according to claim 6, wherein the ingredient combinations include a protein powder, a pre-workout powder, a green powder, and a glutamine powder.

8. The system according to claim 6, wherein each of the ingredient combinations include a digital numerical display each having a first side arrow and a second side arrow that is depressed on the external touch display screen to select a desired quantity of each of the ingredient combinations.

9. The system according to claim 6, further comprising a Make Your Own button disposed on the first graphical user interface that is depressed after selecting a desired quantity of each of the ingredient combinations to activate the supplement beverage dispensing machine.

10. The system according to claim 6, wherein the non-transitory storage media for using a supplement beverage dispensing machine is controlled by the graphical user interfaces displayed on the external touch display screen.

11. The system according to claim 6, wherein the user touches the graphical user interfaces displayed on the external touch display screen to enter information that is processed by the non-transitory storage media for using a supplement beverage dispensing machine to operate the supplement beverage dispensing machine to make and dispense the desired supplement beverage.

12. The system according to claim 6, wherein a second graphical user interface displayed on the external touch display screen is adapted to allow the user to select a plurality of beverage container sizes for the beverage container containing the supplement beverage.

13. The system according to claim 12, wherein the beverage containers sizes is a large beverage container size or a small beverage container size.

14. The system according to claim 12, wherein the beverage containers are stored within the housing and be automatically retrieved during a dispensing cycle of the supplement beverage dispensing machine.

15. The system according to claim 12, wherein the non-transitory storage media for using a supplement beverage dispensing machine prepares a supplement beverage in the beverage container size with a selected combination of the ingredient combinations and their respective quantities.

16. The system according to claim 15, wherein the user selects the ingredient combinations from each of the beverage ingredient combinations and a dispensing mechanism is adapted to mix ingredients and water from the reservoirs and dispense the resulting supplement beverage.

17. The system according to claim 1, wherein the vending outlet includes a lower tray adapted to support the beverage container.

18. The system according to claim 1, wherein the solid material reservoirs are configured to store one or more protein powders, one or more dried greens powders, one or more pre-workout powders, one or more post-workout powders, or one or more other types of supplement powders.

19. A method for using a supplement beverage dispensing machine, comprising the steps of:
placing a beverage container in the supplement beverage dispensing machine;
orienting the beverage container under a dispensing mechanism of the supplement beverage dispensing machine;
dispensing a supplement beverage into the beverage container with a desired combination of supplement powders and quantities dispensed from the dispensing mechanism; and
ceasing the dispensing mechanism when the beverage container is filled.

20. A non-transitory computer storage media having instructions stored thereon which, when executed, execute a method comprising the steps of:
placing a beverage container in the supplement beverage dispensing machine;
orienting the beverage container under a dispensing mechanism of the supplement beverage dispensing machine;
dispensing a supplement beverage into the beverage container with a desired combination of supplement powders and quantities dispensed from the dispensing mechanism; and
ceasing the dispensing mechanism when the beverage container is filled.
